(19) United States
(12) Patent Application Publication
(10) Pub. No.: US 2018/0159406 A1
(43) Pub. Date: Jun. 7, 2018

(54) Electromagnetic Rotary Motor

(71) Applicant: Maxwell Jordan Blankenship, Fairbanks, AK (US)

(72) Inventor: Maxwell Jordan Blankenship, Fairbanks, AK (US)

(21) Appl. No.: 15/369,151

(22) Filed: Dec. 5, 2016

(51) Int. Cl. H02K 11/33; H02K 1/14; H02K 1/24

(52) U.S. Cl. CPC H02K 11/33; H02K 1/246; H02K 1/14

(57) ABSTRACT

The Electromagnetic Rotary Motor uses the pulling or pushing force created by electromagnets to rotate a shaft and create mechanical energy. There are two main components, the spindle and the track. The spindle is comprised of the main shaft, arms, and heads. The track is a ring with electromagnets and power transfer pads positioned along it. The spindle sits inside the track and rotates. When the heads of the spindle pass by the power transfer blocks, the electromagnet will turn on and pull the heads towards it. Then the electromagnet will turn off, allowing the head to stay on its path. This action happens every time a head aligns with an electromagnet, causing the spindle to rotate creating mechanical energy.

### BACKGROUND OF INVENTION

The Electromagnetic Rotary Motor uses electromagnets as a power source. Electromagnets are constructed by wrapping electrically conductive wire in a coil around a ferromagnetic metal and passing an electrical current through the wire. Putting an electrical current through the wire will cause the metal to act as a magnet. Electromagnets have an attracting force on the end where the electrical current enters the coil and a repelling force on the end where the electrical current exits the coil. When there is no electrical charge passing through the wire, the electromagnet is off and deactivated. Electromagnets yield a large amount of pulling and pushing force with a small amount of electrical power input. Magnetic forces have little effect on aluminum and copper, while maintaining a strong effect on ferromagnetic metals.

### FIELD OF THE INVENTION

### Electrical Motor

### BRIEF SUMMARY OF THE INVENTION

The Electromagnetic Rotary Motor uses pulling or pushing force created by electromagnets to rotate a shaft and create mechanical energy. There are two main components, the spindle and the track. The spindle is comprised of the main shaft, arms, and heads. The spindle sits inside the track and rotates about the center of the main shaft. The track is a ring with electromagnets and power transfer pads placed along the perimeter. The electromagnets use their attracting or repelling force to move the heads in a circular path causing the main shaft to revolve.

### DESCRIPTION OF DRAWINGS

FIG. 1: Cross-section of the spindle.

FIG. 2: Power transfer cap and the input end of the spindle.

FIG. 3: Cross section of a head connected to an arm.

FIG. 4: Output end of the motor displaying the arms and heads sitting inside the track.

FIG. 5: Components of electromagnet on the track

FIG. 6: Rotation of the spindle within the track.

### DESCRIPTION

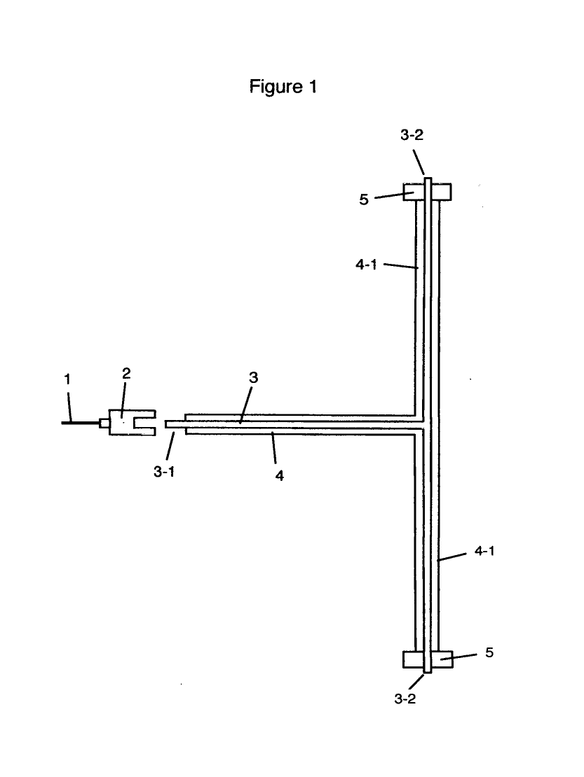

Displayed in FIG. 1 is the spindle. The spindle consists of the main shaft (4), arms (4-1) and heads (5). The main shaft and arms are constructed of aluminum and are hollow. Copper fills the inside of the hollow section of the main shaft and arms. Heads comprised of a ferromagnetic material are attached to the end of each arm (5). Holes in the heads allow the protruding copper (3-2) to pass through the head.

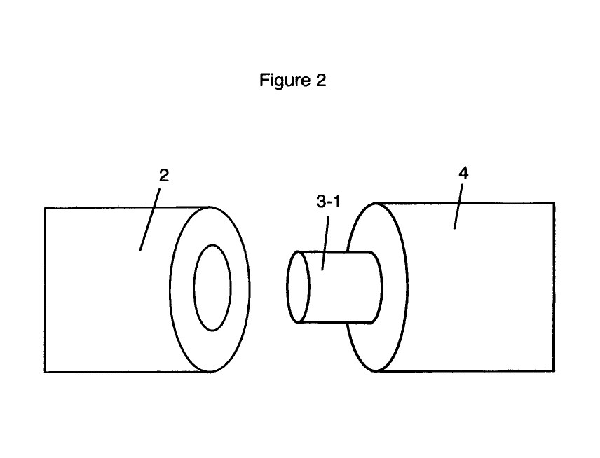

Displayed in FIG. 1 and FIG. 2, the power transfer cap (2) sits around the protruding copper (3-1) of the main shaft. The power transfer cap is constructed out of an electrically conductive material. The diameter of the hole in the power transfer cap is slightly larger than the diameter of the copper protruding from the spindle. The gap between the protruding copper and the power transfer cap is filled with a conductive lubricant. The input wire (1) is connected to a power supply to the power transfer cap.

The end of the motor with the power transfer cap is the input end. The end of the motor with the arms and heads is the output end.

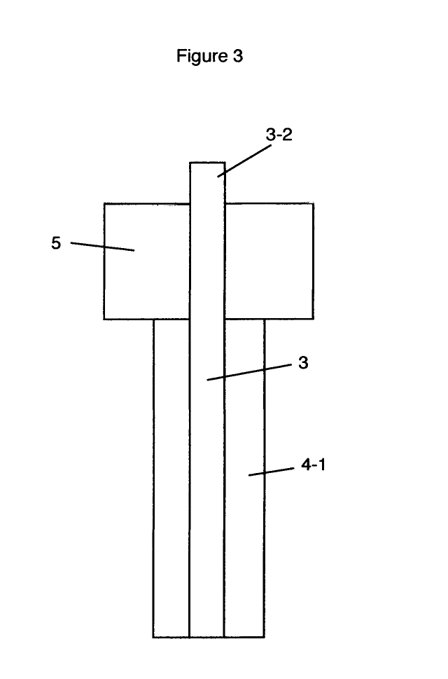

Displayed in FIG. 3, the heads (5) are constructed of a ferromagnetic material and attached to the ends of each arm. Each head has a hole through the center from top to bottom to allow the protruding copper (3-2) to stick out of the end of the head. This allows the protruding copper to be in contact with the power transfer pads when the spindle rotates around.

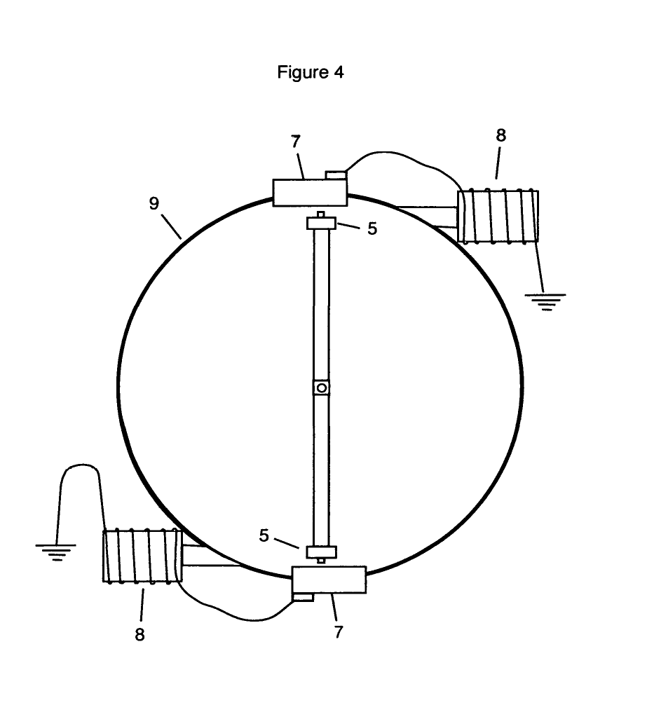

Displayed in FIG. 4 is the output end of the spindle and the track. The main shaft of the spindle sits perpendicular to the track. The track (9) is a ring made from a non-magnetic material. Power transfer pads (7) and electromagnets (8) are placed along the track. The power transfer pads and electromagnets are positioned in a manner when a head (5) aligns in front of an electromagnet; the protruding copper (3-2) is in contact with that electromagnet's power transfer pad (7). The space between the top of the head and the bottom of the power transfer pad is small. This allows only the protruding copper to touch the power transfer pad when the heads rotate around. The power transfer pads are made from an electrically conductive material allowing an electrical charge to pass through them.

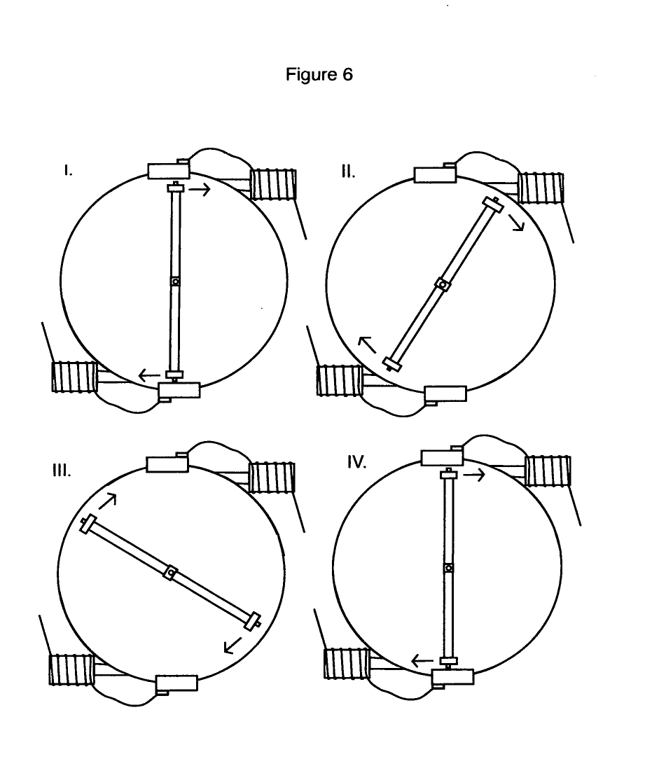

Displayed in FIG. 5, connected to each power transfer pad (7) around the track (9) is an electrically conductive wire (8-1). The wire is wrapped in a coil around the core of the electromagnet (8-2). After the wire is wrapped around the core, it is connected to a grounding source (8-4). A mount (8-3), constructed of a non-magnetic material, is used to attach the electromagnets to the track.

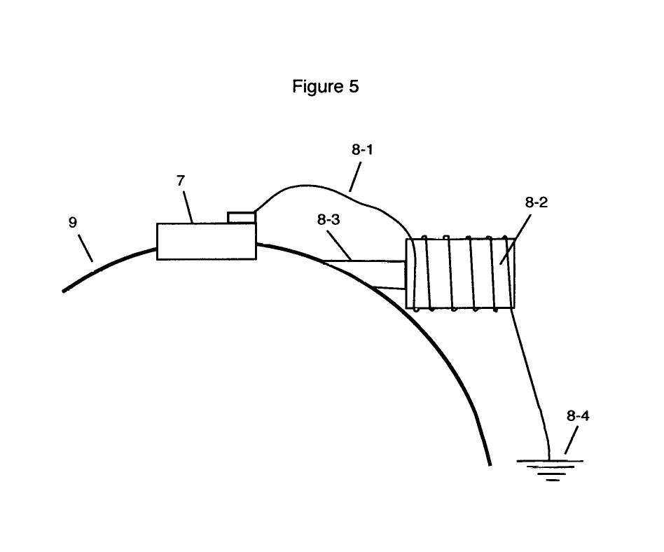

FIG. 6 displays the motion of the spindle rotating within the track. The rotation goes in order of roman numeral (I.), roman numeral (II.), roman numeral (III.), roman numeral (IV.).

When an electrical power source is connected to the input wire (1), the electrical current is transferred from the input wire to the power transfer cap (2). The current is carried through the power transfer cap (2), through the conductive lubricant, and into the copper (3-1, 3) of the spindle. The electrical current continues through the copper (3) and into the copper hairs (3-2). When the spindle rotates around, the protruding copper will touch the power transfer pads (7). When the protruding copper (3-2) is in contact with a power transfer pad (7), the electrical current is a transferred to the power transfer pad. The current then passes through electrically conductive wire (8-1) wrapped around the electromagnet's core (8-2). This creates a pulling force from the electromagnet only when the protruding copper (3-2) is in contact with the power transfer pad (7). This force pulls the head (5) towards the electromagnet while the protruding copper (3-2) is in contact with a power transfer pad (7). This allows each head to continue traveling along its paths after being pulled by the electromagnet. Once the electrical current has passed through the electromagnet (8), it will flow to the grounding source.

When a constant electrical current is applied to the Electromagnet Rotary Motor, the head and arms move in a circular path around the center of the main shaft. This causes the main shaft (4) to revolve and create mechanical energy. A gear can be mounted to the output end of the spindle in order to supply power to a machine.

The number of arms on the spindle and electromagnets on the track can be adjusted to optimize power output.

The motor can also be operated in the opposite direction that is displayed. By reversing the flow of electricity through the electromagnets (8), this will cause the electromagnets to push the heads instead of pulling them when the protruding copper (3-2) is in contact with a power transfer pad (7). This is done by grounding the wire connected to the power transfer cap (1) and connecting the wires from the electromagnets to an electrical power source. This will switch the flow of electricity through the motor and through the electromagnets causing the electromagnets to push when a head (5) passes by the power transfer pad (7).

I: An electromagnet is a magnet which produces a magnetic field by running an electrical current through wire.

II: The Electromagnetic Rotary Motor uses the attracting force generated by electromagnets to move an object in a circular path, said object is attached to a shaft which spins when the motor is on.

III: The Electromagnetic Rotary Motor uses the repelling force generated by electromagnets to move an object in a circular path, said object is attached to a shaft which spins when the motor is on.
